(19) United States
(12) Patent Application Publication
(10) Pub. No.: US 2003/0015866 A1
(43) Pub. Date: Jan. 23, 2003

(54) Integrated optical viewer for secure documents

(76) Inventors: Mark M. Cioffi, West Sand Lake, NY (US); David E. Washburn, Kettering, OH (US); Dale Lake, Dayton, OH (US); John M. Harden, Oxford, NC (US)

Correspondence Address: Killworth, Gottman, Hagan & Schaeff, L.L.P., One Dayton Centre, Suite 500, Dayton, OH, 45402-2023, US

(21) Appl. No.: 09/909,210

(22) Filed: Jul. 19, 2001

(51) Int. Cl. B42D 15/00

(52) U.S. Cl. 283/72

(57) ABSTRACT

A form is provided having a fold line dividing the form into a first panel and a second panel. Hidden information is provided within the first panel. The second panel is suitably impregnated with a transparentizing composition such that a transparentized window portion is defined integral with the second panel. A decoder is constructed comprising the transparentized window portion. The positioning of the hidden information within the first panel, and the decoder in the second panel is such that when the form is folded along the fold line, the hidden information becomes apparent to a user by viewing the first panel in conjunction with the decoder.

### BACKGROUND OF THE INVENTION

The present invention relates in general to a secure document and in particular to a secure document including encoded information and a built-in decoder.

There are numerous applications where information contained on a document is not intended to be readily discernable. These include situations where it is beneficial either to provide authentication of a particular document, or alternatively to encode or scramble printed information such that the information can be decoded or descrambled when the appropriate decoding mechanism is applied to the scrambled information. Typically, a handheld decoder is placed over the scrambled information to render it apparent to a viewer of the document. For example, it may be desirable to encode information on business forms or other items such as identification cards, credit cards, or the like. Further, documents bearing scrambled information can also be used for promotional purposes, where the act of decoding information provides an entertaining activity.

In one known encoding system, original information is recorded onto a recording element through the combination of an optical system and an information transformation medium. The optical system forms an image of the original information. The information transformation medium, such as a lenticular plate, transforms the image of the original information to an encoded image in the form of a large number of focused lines parallel to the generating line of the lenticular plate. Next, camouflaging and concealing information is recorded over the encoded image of the original information using the same optical system and lenticular plate, however, the lenticular plate is shifted, moved or angled to a different position. However, to descramble the information, a user must possess the lenticular plate used to encode the original information. Further, the user must manually align the lenticular plate to the same position used to record and encode the original information. Aligning the lenticular plate to the proper position can be difficult and time consuming. Further, should the lenticular plate become lost or misplaced, the original information cannot be easily decoded.

In another coding technique, at least a portion of the information to be decoded is hidden from view, or disguised. For example, a series of parallel lines are provided to mask a base image. Meaningless and extraneous information is further printed about the base image to provide a disguise and camouflage. To decode the base image, a separate mask is provided. By overlaying and suitably aligning the mask over the base image, the parallel lines and extraneous information may be filtered out by the mask revealing only the base image. This technique may be practiced manually, for example using photographic techniques where images are superimposed onto one another, or electronically whereby digital images are superimposed and filtered. However, this technique requires a separate mask to decode the image. The mask may be difficult to align with the image, and may further become lost or stolen because it is not attached to the document for which it is intended to decode. Further, depending upon construction techniques selected, the complexity of the coding may be limited by the ability to fabricate a suitable mask. Also, if practiced electronically, sophisticated electronics such as computers and printers may be required to decode the image. This drastically limits the portability and cost effectiveness of the encoding system.

Accordingly, there is a need for a form having both coded information and a built-in decoder within the same document.

### SUMMARY OF THE INVENTION

The present invention overcomes the disadvantages of previously known coding techniques wherein a form is provided having a fold line dividing the form into a first panel and a second panel. Hidden information is provided on the first panel, and a corresponding decoder is provided in the second panel. The positions of the hidden information on the first panel, and the decoder in the second panel are such that when the form is folded along the fold line, the hidden information becomes apparent to a user by viewing the first panel in conjunction with the decoder.

In accordance with one embodiment of the present invention, a form comprises a cellulosic sheet having a first fold line dividing the sheet into a first panel and a second panel. A coded image is positioned within the first panel and an image decoder is positioned within the second panel. The sheet is foldable such that, upon folding the sheet, the image decoder is brought in register with the coded image thus descrambling the coded image for a user viewing the first panel in conjunction with the image decoder. It will be appreciated that virtually any known coding and decoding techniques may be used within the spirit of the present invention. For example, the coded image may be hidden unless rendered unhidden by placing the image decoder in register with the coded image. The image may be hidden by de-emphasizing the image, scrambling the image, camouflaging the image, or any combination thereof. The camouflage may comprise one or more images commingled with the image. Further, the image decoder may define a mask such that the decoded image is derived from a combination of a hidden image on the first panel, and an additional image on the image decoder. Under this arrangement, either additive, or subtractive techniques may be employed.

Where the coded image is camouflaged by the placement of images or other information superposed over the coded information, the image decoder may comprise a mask or filter that corresponds to the camouflage data such that the image decoder either blocks at least a portion of the camouflage sufficient to render the coded image within the first panel determinable, or alternatively, accentuates the coded image such that the coded image is rendered determinable.

The image decoder may be a transparentized portion formed within the second panel, or alternatively, the image decoder may comprise a transparent patch secured to the second panel, overlying a window in the second panel. Further, the image decoder may include a Fresnel lens, an embossed arrangement defining a diffraction grating, or an image printed in a pattern unique to the coded image.

The information may be coded into a raster file and printed onto the sheet. For example, the coded image may be printed in a half tone background pattern. Optionally, the coded image and/or the image decoder may comprise a monochrome tint. Further, the coded image may be scrambled at a first frequency such that the first frequency is optimally required to decode the coded image.

In accordance with another embodiment of the present invention, a business form comprises a cellulosic sheet having a fold line dividing the sheet into a first panel and a second panel. A hidden image is printed on the first panel. The second panel is suitably impregnated with a transparentizing composition such that a transparentized window portion is defined integral with the second panel. A decoder is constructed comprising the transparentized window portion. The decoder is positioned within the second portion such that the decoder may be brought in register with the hidden image when the sheet is folded about the fold line, revealing a decoded image from the hidden image when viewing the first panel in conjunction with the decoder.

In accordance with yet another embodiment of the present invention, an image decoding device comprises a cellulosic sheet having a sheet face and a fold line dividing the sheet into a first panel and a second panel. The second panel has a window portion that has been impregnated with a suitable transparentizing composition. A raster image has an information portion and a decoding portion, wherein the information portion is coded. The raster image is applied to the sheet face such that the decoding portion aligns on the transparentized window portion, and the coded information portion is applied to the first panel such that folding the sheet about the fold line, the decoding portion is brought in register with the information portion so as to descramble and make apparent the information portion to a user viewing the information portion in conjunction with the decoding portion.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals, and in which:

FIG. 1 is a plan view of the front side of a first embodiment of the form of the present invention, with the form in an unfolded position;

FIG. 2 is a plan view of the front side of a second embodiment of the form of the present invention, where the form includes two individual form parts bonded together along a common edge;

FIG. 3 is a diagrammatic view illustrating folding the embodiments of FIGS. 1 and 2;

FIG. 4 is a diagrammatic view illustrating folding the embodiments of FIGS. 1 and 2 as seen from the edge of the form, such that scrambled information may become apparent to a user by viewing the first panel in conjunction with the decoder in the second panel;

FIG. 5 is a plan view of the embodiments of FIGS. 1 and 2 in a folded position, illustrating the manner in which the scrambled information becomes apparent to a user by viewing the first panel in conjunction with the decoder in the second panel;

FIG. 6 is an orthogonal view of the decoder of the embodiments of FIGS. 1 and 2, in which the decoder is implemented as a Fresnel lens;

FIG. 7 is a diagrammatic view of the decoder of FIG. 6 shown in a cross section;

FIG. 8 is a plan view of the top of the decoder of the embodiments of FIGS. 1 and 2 in which the decoder is implemented as a defraction grating;

FIG. 9 is a plan view of the front side of another embodiment of the form of the present invention in an unfolded position wherein information is scrambled onto a first panel of the form, and the appropriate decoder is provided on a second panel of the form; and,

FIG. 10 is a plan view of the form of FIG. 9, in a first folded position in which the second panel is against the first panel, allowing the scrambled information to become apparent to a user by viewing the first panel in conjunction with the decoder in the second panel.

### DETAILED DESCRIPTION OF THE PREFERRED EMBODIMENTS

In the following detailed description of the preferred embodiments, reference is made to the accompanying drawings that form a part hereof, and in which are shown by way of illustration, and not by way of limitation, specific preferred embodiments in which the invention may be practiced. It will be appreciated that these are diagrammatic figures, and that the illustrated embodiments are not shown to scale. Further, like structure in the drawings is indicated with like reference numerals.

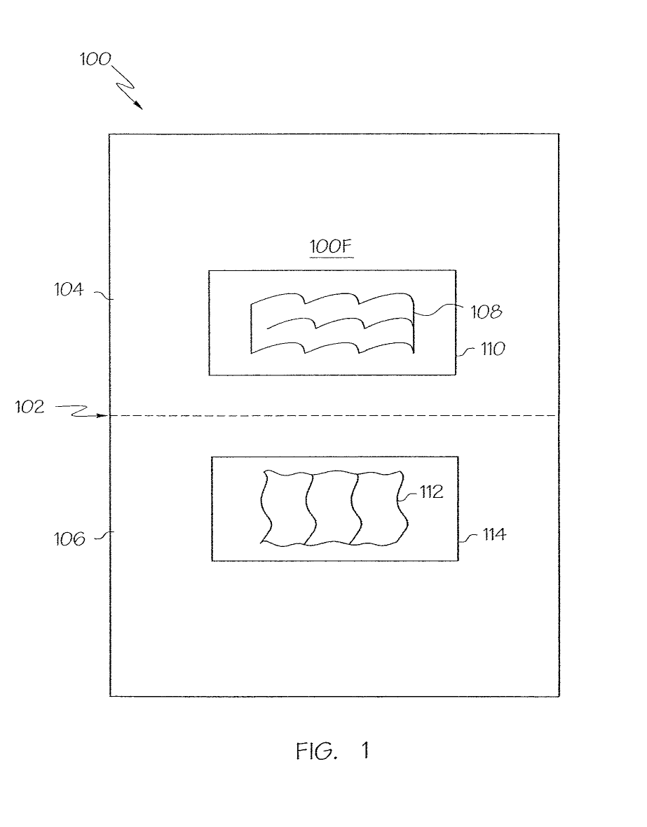

A form comprising a first embodiment of the present invention is illustrated in FIG. 1. A sheet 100 has a sheet face 100F, and a fold line 102 spanning transversely across the sheet 100 dividing the sheet 100 into a first panel 104 and a second panel 106. The fold line 102 thus defines a common edge between the first and second panels 104, 106. Hidden information 108 is printed on face 100F in an area 110 within the first panel 104. A decoder 112 is provided within the second panel 106. The phrase “hidden information” means any type of image that is generally not readily recognizable by an observer viewing the area 110. The hidden information may be encoded, camouflaged, distorted, stretched, filtered or otherwise effected. It shall be appreciated that a careful observer upon scrutinizing the hidden information may be able to decipher all or a portion of the hidden information depending upon the sophistication of the manner used to encode or otherwise hide the information. Such information is still considered “hidden” within the spirit of the present invention. The term “decoder” means any sort of optical device that renders the hidden information apparent to an observer when the hidden information 108 is viewed through the decoder 112.

Hidden information 108 is information printed on the first panel 104 within an area generally designated with the reference numeral 110. Hidden information 108 is hidden, camouflaged, concealed, coded, scrambled, distorted or otherwise not readily discernable to a viewer of the first panel 104. It should be appreciated that the hidden information 108 can include text, graphics, or any other data. Further, it will be appreciated that virtually any technique may be used to create the image of the hidden information 108, as more fully described herein, so long as a complementary decoder 112 can be constructed within the second panel 106 such that, upon folding the sheet 100 about the fold line 104, the hidden information 108 is rendered apparent when viewed in conjunction with the decoder 112.

The decoder 112 is positioned in the second panel 106 such that when the sheet 100 is folded along fold line 102, the decoder 112 is brought into registration with the area 110, allowing the hidden information 108 to be viewed through the decoder 112. The hidden information 108 is thus rendered apparent to a person viewing the hidden information 108 using the decoder 112.

The window 114 is a transparentized area formed within the sheet 100. For example, where the sheet 100 comprises a cellulosic substrate such as paper, a transparentizing composition may be used to define the window 114 integral with the sheet 100. A suitable transparentizing composition is disclosed in U.S. Pat. Nos. 5,418,205 and 6,143,120 to Mehta et al., and U.S. Pat. No. 6,103,355 to Mehta, all of which are assigned to Standard Register Company, and herein incorporated by reference. Under this arrangement, a cellulosic substrate is impregnated within the area defining the window 114 with a liquid polymerizable transparentizing composition. Upon curing the transparentizing material by exposure to radiation, a substantially transparent area is realized. It shall be appreciated by those skilled in the art that other transparentizing compositions may be used to impregnate the sheet 100 so long as a sufficiently transparent window 114 can be formed, and further that a decoder can be constructed on the window. Additionally, the sheet 100 may be of any size or geometry depending upon the intended use, and may be incorporated into a mailer, a business form, security document, or any other type of document.

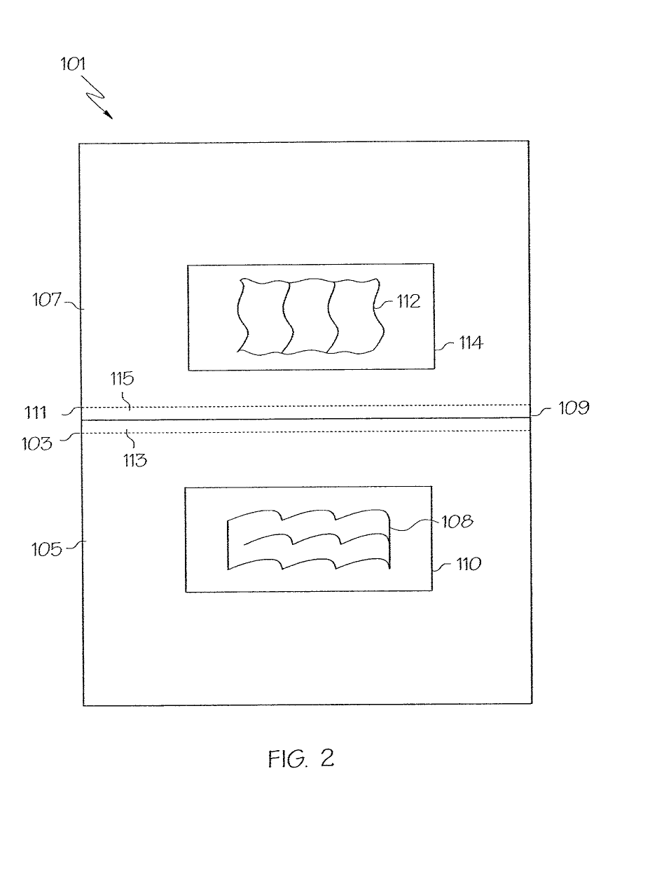

The form may also be constructed from multiple individual parts. Referring to FIG. 2, a two-part form according to one embodiment of the present invention is illustrated. The two-part form 101 includes a first panel 105 and a second panel 107. The first and second panels 105 and 107 are comprised of individual sheets that are bonded together using techniques known in the art. The first panel 105 includes hidden information 108 as described more fully herein. Further, the first panel 105 may be constructed from any number of materials as is known in the art, including by way of example, paper, latex impregnated paper, synthetic paper, thermal sensitive film, polyolefin, polypropylene, polyester film, and vinyl.

The window 114 is a transparentized area formed within the second panel 107. For example, where the second panel 107 comprises a cellulosic substrate such as paper, a transparentizing composition may be used to define the window 114 integral with the second panel 107 as more fully described herein.

The two-part form 101 is constructed by superimposing the second panel 107 on top of the first panel 105. Further, the first and second panels 105, 107 are preferably bonded together along a common edge 109. For example, as shown in FIG. 2, perforations 103, 111 are spaced generally an equal distance from, and in opposite directions of the common edge 109. A first area 113 is defined between the common edge 109 and the perforation 103. A second area 115 is defined between the common edge 109 and the perforation 111. The two-part form 101 is shown in FIG. 2 with the second panel 107 folded back along common edge 109 to facilitate discussion and illustrate features of both the first and second panels 105 and 107. However, normally the second panel 107 is superimposed on the first panel 105 and is substantially aligned along the common edge 109. Further, the second panel 107 is bonded to the first panel 105 by applying an adhesive or glue for example, between the first and second areas 113, 115. It shall be appreciated that other bonding techniques may be used to secure the second panel 107 to the first panel 105.

The two-part form 101 is constructed such that a user can superimpose the first and second panels 105, 107 such that the decoder 112 is properly registered with the hidden information 108. For example, where the second panel 107 is superimposed on the first panel 105 as described above, the window 114 on the second panel 107 will automatically align with the hidden information 108 on the first panel 105. Further, the two-part form may comprise additional processing features common to two-part form construction as is known in the art.

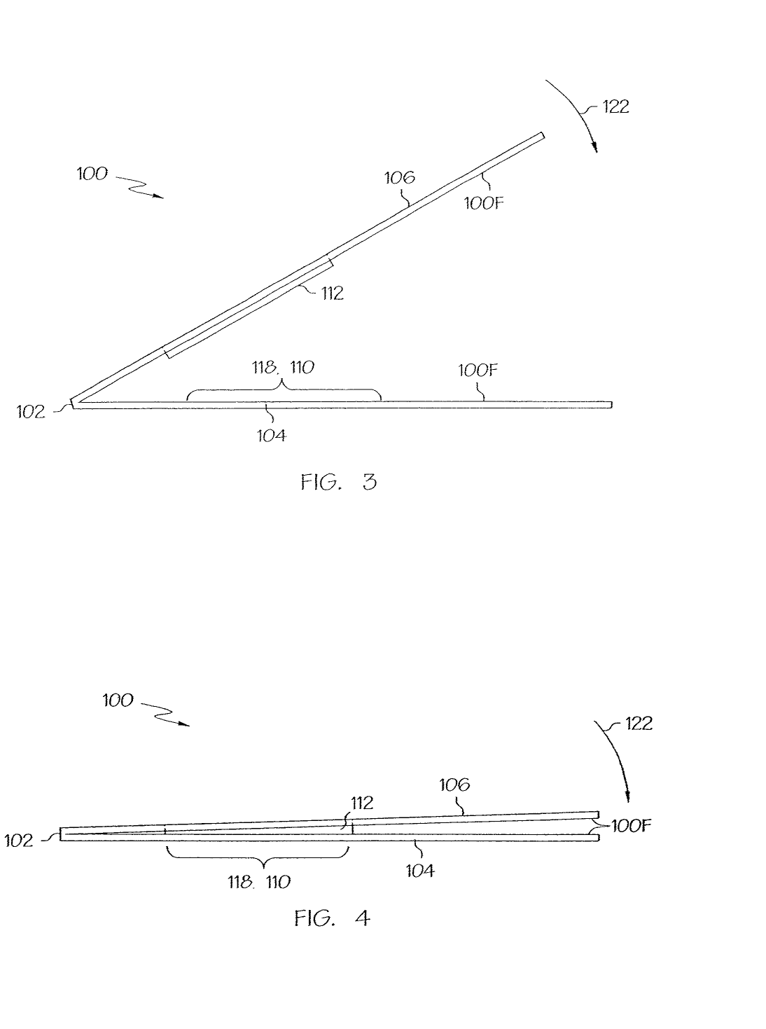

Sheet 100, as shown in FIGS. 3 and 4 is folded along fold line 102, in a first direction according to the first directional arrow 122. When the fold is completed, the second portion 106 is folded over onto the first portion 104, and the decoder 112 is superimposed over the area 110, and particularly, the hidden information 108 (not shown). This explanation applies likewise to the two-part form shown in FIG. 2 where the first and second panels 105 and 107 are bonded along the common edge 109.

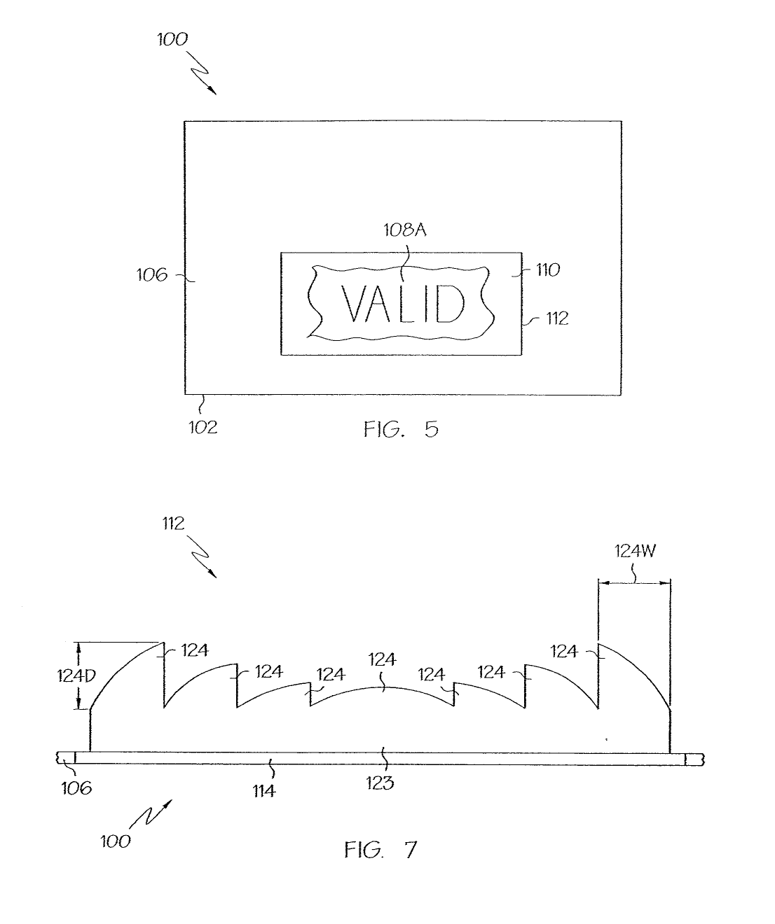

It should be observed that, while the decoder is shown in FIGS. 3 and 4 on the sheet face 100F such that the decoder 112 is positioned on the inside of the fold, the decoder 112 may also be placed on the back of the sheet 100 such that the decoder 112 is on the outside of the fold. The orientation and position of the decoder 112 will depend upon the techniques used to create the hidden information 108 as more fully described herein. The completed fold is illustrated in FIG. 5. The decoder 112 is positioned to cooperate with the area 110, such that when a user views the hidden information 108 (not shown in FIG. 5) through the decoder 112, a decoded version 108A (the word “VALID” is shown) of the hidden information 108 becomes apparent.

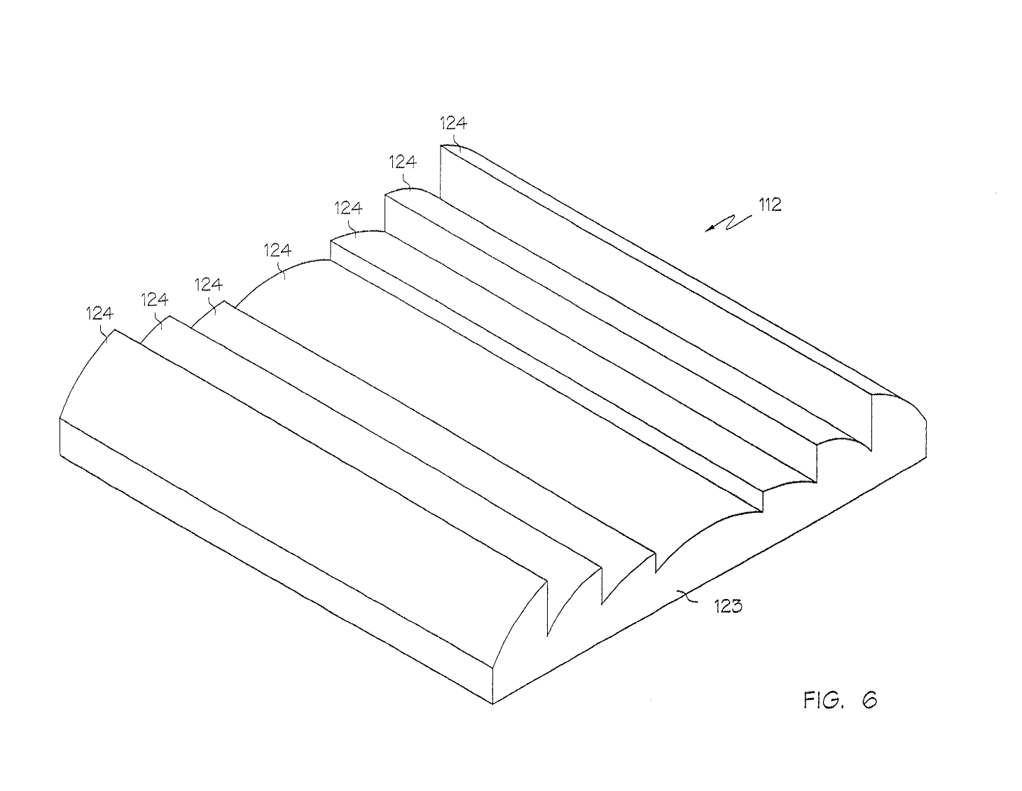

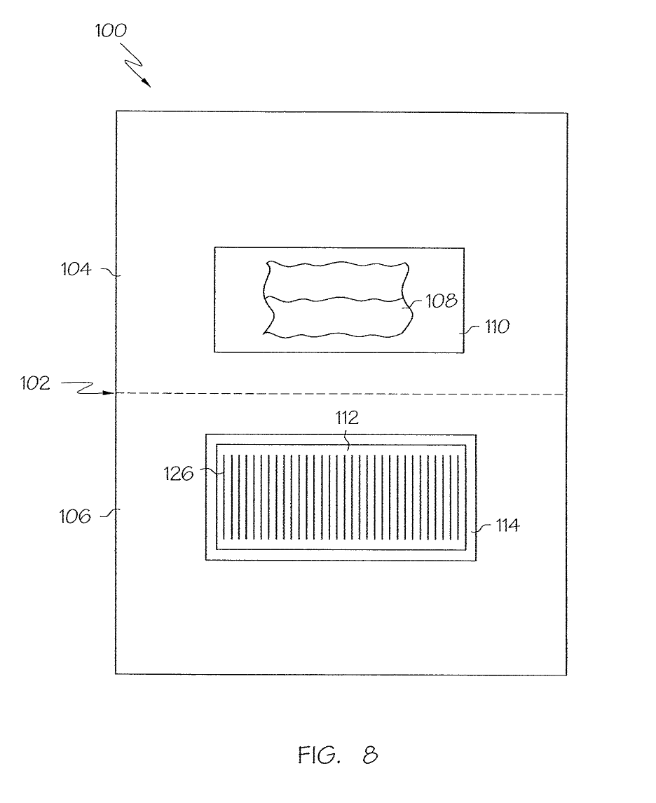

With respect to either the first embodiment shown in FIG. 1 or the second embodiment shown in FIG. 2, the decoder 112 may be printed information applied to the window 114, embossed or engraved into the window 114, a molded portion of the window construction, an additional optical element added to the window 114, or combination of the above. For example, the decoder 112 may include an optical element 123 such as a magnifying glass, lenticular lens, or Frensel lens. An optical element 23 that is similar to a Fresnel lens as shown in FIGS. 6 and 7. The lens shown in FIGS. 6 and 7 is a typical Fresnel lens wherein a series of parallel grooves 124 are formed in a suitable optical material. It is preferable that the grooves 124 have generally constant groove width 124W, and variable groove depth 124D. As best shown in FIG. 7, one side of each groove is defined by a surface that is generally cylindrical and concentric with the other groove surfaces. The grooves 124 act as refracting surfaces, bending parallel rays of light to a common focus. The grooves 124 may be generally cylindrical, circular or other suitable shapes. By varying the material selected, the groove depth 124D and the groove width 124W, the focal length and other aspects of the lens may be manipulated.

With a decoder 112 configured as shown in FIGS. 6 and 7 as a Fresnel lens, or a similar lens structure, the image of the hidden information is scrambled or encoded prior to printing it on the sheet 100. It will be appreciated that the decoder 112, configured as a Fresnel lens, has lens power in only one direction. As a consequence, the ability of the Fresnel lens to decode an image is limited to the one direction. The hidden information image is therefore scrambled in one direction in a manner such that the optical alteration of the image by the decoder 112 in that direction returns the hidden information 108 to its original appearance, rendering it recognizable. Since the hidden information 108 is encoded in only in one direction, and since the decoder 112 is arranged to decode an image in only one direction, it is necessary for such an arrangement that the decoder 112 be properly oriented with respect to the hidden information 108. Since the decoder 112 is affixed to the second panel 106, such a proper orientation of the decoder 112 is assured as the sheet 100 is folded along the fold line 102 and the decoder 112 is brought in registration with the hidden information 108 as more fully described herein.

It will be appreciated that other optical lens arrangements may be used as decoders in forms constructed according to the present invention. For example, an optical lens arrangement having optical power in two orthogonal directions may be used as the decoder 112. Such a decoder will decode the image of the hidden information 108 in two directions. As a consequence, the hidden information printed on a form having such a decoder will necessarily have previously been scrambled or encoded in two directions. In the case of a decoder 112 configured as a lens arrangement having lens power in two directions, the decoder 112 must necessarily be correctly oriented with respect to the hidden information 108. Once again, folding the form along the fold line 102 insures that the proper relative orientation is achieved. It will be understood that the optical lens arrangements discussed above utilize the decoder 112 to unscramble the printed, scrambled image of the hidden information 108. The scrambled image is obtained by altering, distorting or rearranging the image of the hidden information 108 in a manner precisely opposite to that accomplished by the decoder 112. This scrambling of the hidden image may be performed optically or by means of appropriate computer software.

As shown in FIG. 8, the decoder 112 may optionally consist of an embossed area of the window, approximating a diffraction grating. As such, the decoder 112 will serve to separate polychromatic light spatially into its constituent optical frequencies. The decoder 112 includes a series of parallel, equispaced grooves 126. The decoder 112 separates light passing therethrough into one or more “orders” according to its grating equation, based upon the angle of incidence of incoming light. As an alternative, grooves 126 may be replaced by a corresponding series of parallel, equispaced slits in the window 114. It will be appreciated that the diffraction grating decoder, like the Fresnel lens decoder and the other decoder variations mentioned above, takes a scrambled or encoded image of the hidden information that appears in area 110 and unscrambles or decodes the image to make it recognizable.

Other embodiments of the present invention may incorporate a decoder that includes a portion of the image of the hidden information 108. That is, the image of the hidden information 108 is separated into two, separate images, neither of which is recognizable by itself. When the two, separate images are superimposed, however, as when the decoder 112, bearing one-half of the coded image is placed over the area 110 bearing the other half of the coded image, the image then becomes apparent to an observer. Under this arrangement, the hidden information 108 and the decoder 112 may be printed from the same plate, and thus the same ink.

It will be appreciated that the complete image of the hidden information 108 may be dissected into two, unrecognizable images in a number of ways, including a manual separation of the image. The image could, for example, be cut into two image components and pasted into two image files. Since an individual effects separation of the image manually, the degree to which the half of the printed image in area 110 is unrecognizable is dependent in large measure on the skill of the individual in making this separation.

The separation of the original image may also be accomplished on a pixel-by-pixel basis, with half of the pixels being printed in area 110 and the other half of the pixels being printed on and as a part of the decoder 112. If the size of the pixels selected with such an arrangement is too small, the image of the hidden information will be apparent on both the panel 106 and the panel 104. If the pixels are made larger, however, the images on panels 106 and 104 will not form recognizable images separately. Instead, they will only form a recognizable image as a composite image produced by overlapping the decoder 112 over the area 110 and viewing the area 110 through the decoder 112. For example, the hidden information 108 may comprise a plurality of dots in area 110. Additional dots may be further included within area 110 further providing camouflage. Dots may further provided on the decoder 112. The dots are arranged such that viewing the decoder 112, or area 110 separately, the hidden information is not apparent. When the decoder 112 is brought in register with the area 110, certain of the dots on the decoder align with dots on within area 110, while other dots are slightly phase shifted, such that viewing the area 110 through the decoder 112, the areas containing phase shifted dots will appear darker, or alternatively a different color, rendering information apparent.

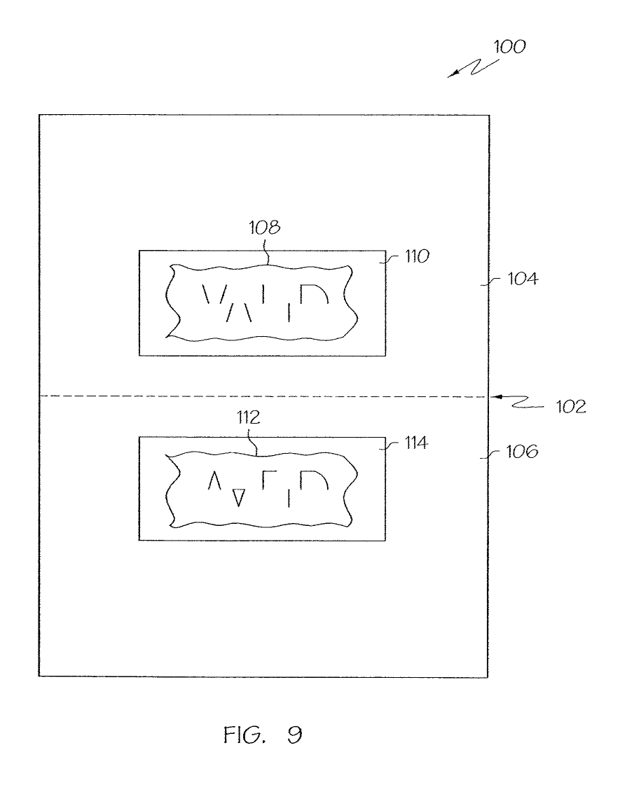

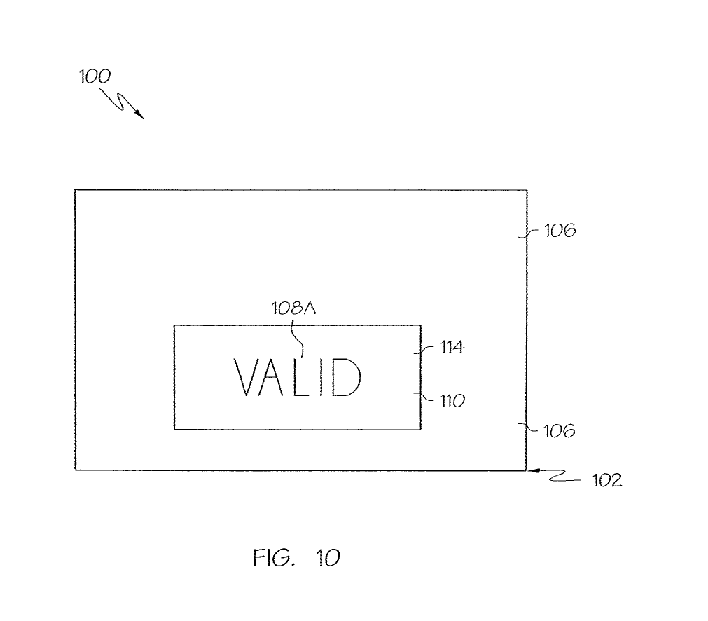

As shown in FIG. 9, the decoder 112 includes a portion of the image of the hidden information, and the region 110 includes the balance of the image of the hidden information. When the sheet 100 is folded along the fold line 102, toward the second panel 106, the decoder 112 is positioned to overlie the print region 110. The image on the decoder 112 in conjunction with the image on the region 110 together produce a recognizable image, such as shown in FIG. 10. The word “VALID” is formed by the composite of these two images.

It will be appreciated that numerous variations and combinations of this hidden information/decoder arrangement may be utilized. For example, a camouflage image may be included on either the decoder or the region 110, or both, which camouflages the images on the decoder 112 and the region 110 when those images are viewed separately but which is less apparent or is less effective when decoder 112 is superimposed over region 110. For example, the hidden information 108 may comprise at least two tints. The decoder 112 is printed in one tint common to one of the tints used to print the hidden information 108. When a user views the hidden information 108 through the decoder 112, the non-common tints are revealed or rendered more apparent. As a simple example, the transparentized window 114 includes a red tint. The hidden information is a jumbled combination of a blue tint and the same red tint used to print the window 114. Upon viewing the hidden information 108 through the window 114, and in particular, the decoder 112, the blue message is revealed.

Likewise, the decoder 112 may be utilized to block out a portion of the camouflaging to reveal the hidden information, or alternatively, the decoder 112 may be utilized to enhance the hidden information 110 such that the hidden information 110 stands out from the camouflage. Repeating picture elements, such as lines, dots, geometric shapes, etc. may be printed across both the decoder 112 and the region 110 at the same spatial frequency. The hidden information 108 may be encoded into the image on region 110 by phase shifting areas of the picture elements and not phase shifting other areas of the picture elements. The phase shifted picture elements then provide a different appearance than that of the picture elements that are not phase shifted when the decoder 112 and the region 110 are in registration. As a consequence, the hidden information will become apparent. It will be appreciated that camouflage images, either subtractive or additive, may be added to the decoder 112, to the region 110, or to both the decoder 112 and the region 110.

Where the hidden information 108 and the decoder 112 are printed at the same time, the decoder 112 may be constructed unique to the corresponding hidden information. For example, a single raster file including the hidden information 108, as well as the decoder 112 can be generated using suitable software. For example, Fusion Screen is a special raster that is generated by the software application Security Expert, which is produced by Ascent Systems Software Ltd. of Cheshire England. With Security Expert, a flat tint can be placed anywhere on the artwork to be printed. The flat tint is monochrome so as to be easily incorporated into a document and print. The original information is coded at a predetermined frequency to define the hidden information 108 in an image. The image may then be printed, for example as a postscript type 1 typeface.

Having described the invention in detail and by reference to preferred embodiments thereof, it will be apparent that modifications and variations are possible without departing from the scope of the invention defined in the appended claims.

What is claimed is:

1. A form comprising:
a first panel;
a cellulosic second panel;
a common edge between said first and second panels;
hidden information printed on said first panel;
at least a portion of said second panel impregnated with a transparentizing composition defining a transparentized window integral with said second panel; and,
a decoder in cooperation with said transparentized window;
wherein said first and second panels are adapted to bring said decoder in registration with said hidden information, thus rendering said hidden information apparent.

2. The form according to claim 1, wherein said transparentized window comprises a polymerizable transparentizing composition that has been cured by exposure to radiation.

3. The form according to claim 1, wherein said cellulosic second panel comprises paper having a portion that has been impregnated by a polymerizable transparentizing composition that has been cured by exposure to radiation defining said transparentized window.

4. The form according to claim 1, wherein said hidden information is rendered apparent by placing said decoder in register with said hidden information, and viewing said hidden information through said decoder.

5. The form according to claim 1, wherein said hidden information comprises a first image and a second image, wherein said second image is superposed on said first image to camouflage said first image.

6. The form according to claim 1, wherein said decoder masks a portion of said hidden information.

7. The form according to claim 1, wherein said decoder comprises a Fresnel lens.

8. The form according to claim 1, wherein said decoder comprises an embossed arrangement defining a diffraction grating.

9. The form according to claim 1, wherein said decoder contains a first image such that when said decoder is brought in register with, and added to said hidden information, said hidden information is rendered apparent.

10. The form according to claim 9, wherein said decoder is printed in a pattern unique to said hidden information.

11. The form according to claim 9, wherein both said hidden information and said decoder are printed in a single pass.

12. The form according to claim 11, wherein both said hidden information and said decoder are printed with the same color ink.

13. The form according to claim 1, wherein said hidden information is printed in a half tone background pattern.

14. The form according to claim 1, wherein said hidden information and said decoder are printed as at least one scrambled raster file.

15. The form according to claim 1, wherein said coded image and said decoder comprise a monochrome tint.

16. The form according to claim 1, wherein said hidden information is scrambled at a first frequency such that said first frequency is optimally required to decode said hidden information.

17. The form according to claim 1, wherein said decoder comprises an optical decoder having lens power in only one direction and said hidden information is scrambled in one direction in a manner such that the optical alteration of the image by said decoder in that direction returns said hidden information generally to its original appearance, rendering it recognizable.

18. The form according to claim 1, wherein said decoder comprises an optical decoder having lens power in two orthogonal directions and said hidden information is scrambled in two orthogonal directions in a manner such that the optical alteration of the image by said decoder returns said hidden information generally to its original appearance, rendering it recognizable.

19. The form according to claim 1, wherein said hidden information is printed in a first plurality of dots, and said decoder comprises a second plurality of dots printed on said transparentized window, wherein said form is foldable such that said decoder is brought in registration with said hidden information such that certain of said second plurality of dots align with respective ones of said first plurality of dots and the remainder of said second plurality of dots align out of phase with associated ones of said first plurality of dots defining out of phase regions such that said out of phase regions appear either a different color or darker than the remainder of said hidden information.

20. The form according to claim 1, wherein said hidden information comprises first repeating picture elements and said decoder comprises second repeating picture elements applied to said transparentized window, wherein said first and second repeating picture elements are applied at the same spatial frequency, wherein said form is foldable such that said decoder is brought in registration with said hidden information such that certain of said second repeating picture elements align with respective ones of said first repeating picture elements and the remainder of said second repeating picture elements align out of phase with associated ones of said first repeating picture elements defining out of phase regions such that said out of phase regions appear either a different color or darker than the remainder of said hidden information.

21. The form according to claim 1, wherein said hidden information is printed in at least two tints, said decoder is printed in at least one tint in common with said at least two tints used to print said hidden information, and said hidden information is printed using at least one non-common tint unique to said hidden information such that when said decoder is brought substantially in register with said hidden information, said non-common tint is rendered apparent.

22. The form according to claim 21, wherein said hidden information is printed as a jumbled combination of said at least two tints.

23. The form according to claim 1, wherein said first and second panels comprise one cellulosic sheet having a fold line defining said first and second panels.

24. The form according to claim 1, wherein said first and second panels comprise individual panels bonded along said common edge.

25. A business form comprising:
a cellulosic sheet having a fold line dividing said sheet into a first panel and a second panel;
hidden information applied to said first panel;
a polymerizable transparentizing composition impregnated into a portion of said second panel defining a transparentized window integral with said second panel; and,
an optical decoder arranged on said transparentized portion;
wherein said optical decoder is brought in register with said hidden information when said sheet is folded about said fold line revealing a decoded image from said hidden information.

26. The business form according to claim 25, wherein said optical decoder comprises a Fresnel lens.

27. The business form according to claim 25, wherein said optical decoder comprises a diffraction grating.

28. The business form according to claim 25, wherein said optical decoder comprises a plurality of slits in said transparentized window.

29. A document comprising:
a paper sheet having a fold line dividing said sheet into a first panel and a second panel;
hidden information applied to said first panel, said hidden information comprising first information and camouflaging information, said first information and said camouflaging information applied to said first panel such that said first information is distorted and generally disguised by said camouflaged information;
a polymerizable transparentizing composition impregnated into a portion of said second panel defining a transparentized window integral with said second panel; and,
a Fresnel lens arranged on said transparentized portion;
wherein said Fresnel lens is brought in register with said hidden information when said sheet is folded about said fold line revealing said first information from said camouflaging information, and generally removing the distortion from said first information such that said first information is apparent.

30. A two-part business form comprising:
a first panel;
a second panel comprised of a cellulosic sheet bonded to said first panel along a common edge;
hidden information applied to said first panel;
a polymerizable transparentizing composition impregnated into a portion of said second panel defining a transparentized window integral with said second panel; and,
an optical decoder arranged on said transparentized portion;
wherein said optical decoder is brought in register with said hidden information when said first and second panels are superimposed revealing a decoded image from said hidden information.

31. The two-part business form according to claim 30, wherein said optical decoder comprises a Fresnel lens.

32. The two-part business form according to claim 30, wherein said optical decoder comprises a diffraction grating.

33. The two-part business form according to claim 30, wherein said optical decoder comprises a plurality of slits in said transparentized window.

34. A two-part document comprising:
a first panel;
a second panel comprising a paper sheet bonded to said first panel along a common edge;
hidden information applied to said first panel, said hidden information comprising first information and camouflaging information, said first information and said camouflaging information applied to said first panel such that said first information is distorted and generally disguised by said camouflaged information;
a polymerizable transparentizing composition impregnated into a portion of said second panel defining a transparentized window integral with said second panel; and,
a Fresnel lens arranged on said transparentized portion;
wherein said Fresnel lens is brought in register with said hidden information when said first and second panels are superimposed revealing said first information from said camouflaging information, and generally removing the distortion from said first information such that said first information is apparent.
